(19) United States
(12) Patent Application Publication
(10) Pub. No.: US 2026/0346359 A1
(43) Pub. Date: Nov. 5, 2026

(54) ROBOT

(71) Applicant: FANUC CORPORATION, Yamanashi (JP)

(72) Inventors: Toshihiko INOUE, Yamanashi (JP); Takeshi TSUMURA, Yamanashi (JP); Kaname KIKUCHI, Yamanashi (JP); Kazuhiro WATANABE, Yamanashi (JP); Tooru NAGAI, Yamanashi (JP); Akihiro OIKAWA, Yamanashi (JP)

(21) Appl. No.: 19/485,949

(22) PCT Filed: Sep. 29, 2023
(86) PCT No.: PCT/JP2023/035600

§ 371 Date: Nov. 19, 2025

(30) Foreign Application Priority Data
May 31, 2023 (WO) PCT/JP2023/020199

(51) Int. Cl. B23K 9/133; B25J 15/00; B25J 19/00

(52) U.S. Cl. CPC B23K 9/133; B25J 15/0019; B25J 19/0075

(57) ABSTRACT

A robot includes a first arm supported to be rotatable about a first axis, and a second arm supported to be rotatable about a second axis, wherein the first arm or the second arm is provided with a device installation section on which a relay device can be installed, the device installation section is positioned between the first axis and a distal end of the second arm, and the device installation section is configured to install the relay device thereto such that an intermediate portion in the longitudinal direction of a first wire material or a second wire material is disposed in a path intersecting the second axis, wherein the first wire material extends along the first arm and that is connected to the relay device and the second wire material extends from the relay device toward a distal-end side of the second arm.

### CROSS-REFERENCE TO RELATED APPLICATION(S)

This is a National Stage Entry into the United States Patent and Trademark Office from International Patent Application No. PCT/JP2023/035600, filed on Sep. 29, 2023, which also relies on and claims priority to International Patent Application No. PCT/JP2023/020199, filed on May 31, 2023, the entire contents of both of which are incorporated herein by reference.

### FIELD OF THE INVENTION

The present disclosure relates to a robot.

### BACKGROUND OF THE INVENTION

There is a known robot including, on an outer surface of a robot arm, a wire feeding device that feeds a welding wire pulled out from an external wire reel to a welding torch mounted on a distal end of the robot arm (for example, see Japanese Unexamined Patent Application, Publication No. 2009-006454).

A conduit pipe into which the welding wire pulled out from the wire reel is inserted is connected to a rear end of this wire feeding device.

### SUMMARY

An aspect of the present disclosure is a robot including: a first arm supported to be rotatable about a first axis; a second arm supported to be rotatable about a second axis parallel to the first axis with respect to the first arm; and a wrist unit supported, at a distal end of the second arm, to be rotatable about a third axis extending along a plane that is offset by a prescribed amount with respect to a plane including the second axis, wherein the first arm or the second arm is provided with a device installation section on which a relay device can be installed, the device installation section is positioned between the first axis and a distal end of the second arm, and the device installation section is configured to install the relay device thereto such that a first wire material that extends along the first arm and that is connected to the relay device and a second wire material that extends from the relay device toward a distal-end side of the second arm are orthogonal to the second axis and extend along a plane that includes the third axis, and an intermediate portion in the longitudinal direction of the first wire material or the second wire material is disposed in a path intersecting the second axis.

### BRIEF DESCRIPTION OF DRAWINGS

FIG. 1 is a side view showing a robot according to a first embodiment of the present disclosure.

FIG. 2 is a cross-sectional view showing a configuration of a second arm of the robot in FIG. 1.

FIG. 3 is a diagram showing, in outline, a wire feeding device of the robot in FIG. 1.

FIG. 4 is a side view showing a first modification of the robot in FIG. 1.

FIG. 5 is a diagram showing, in outline, a modification of the second arm of the robot in FIG. 1.

FIG. 6 is a side view showing a second modification of the robot in FIG. 1.

FIG. 7 is a side view showing a third modification of the robot in FIG. 1.

FIG. 8 is a diagram showing, in outline, a configuration of a second arm of the robot in FIG. 7.

FIG. 9 is a diagram showing, in outline, a configuration of a modification of the second arm of the robot in FIG. 7.

FIG. 10 is a diagram showing, in outline, a configuration of another modification of the second arm of the robot in FIG. 7.

### DESCRIPTION OF EMBODIMENTS

In a conventional robot, it is necessary to increase the bending radius of a bent portion of a conduit pipe as much as possible in order to enhance the feedability of the welding wire. In addition, when the conduit pipe is strongly shaken in association with the operation of the robot, it is conceivable that the conduit pipe interferes with a peripheral member or the like.

Therefore, it is desirable that, while ensuring a large bending radius of a wire material connected to a relay device, such as a wire feeding device, mounted on a robot, said wire material be prevented from being strongly shaken when the robot is operated.

A robot 100 according to an embodiment of the present disclosure will be described below with reference to the drawings.

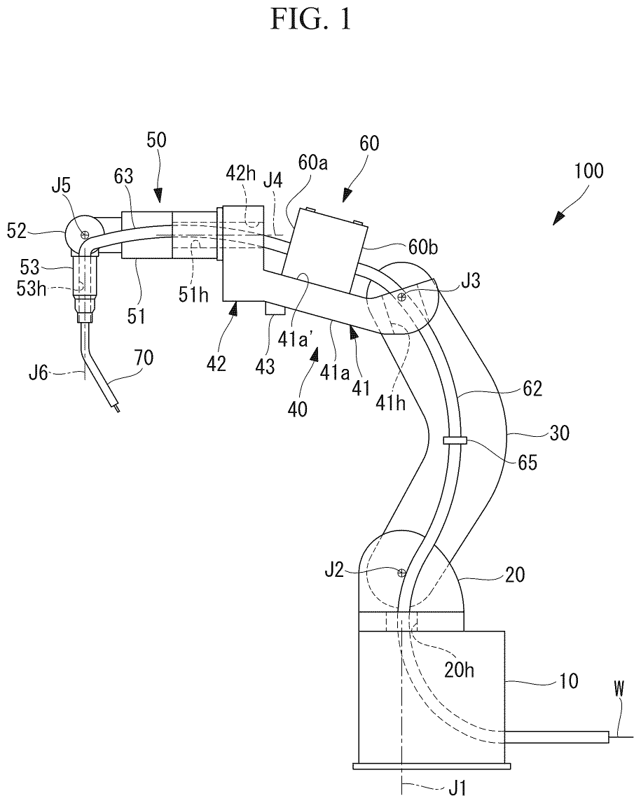

The robot 100 according to this embodiment is, for example, a vertical six-axis articulated robot utilized as a welding robot, as shown in FIG. 1.

The robot 100 includes: a base 10 that is installed on an installation surface, such as a horizontal floor surface; and a rotation body 20 that is supported to be capable of rotating about a vertical first axis (basic axis) J1 with respect to the base 10. The robot 100 includes a first arm 30 that is supported to be capable of rotating about a horizontal second axis (first axis) J2 with respect to the rotation body 20. In addition, the robot 100 includes a second arm 40 that is supported to be capable of rotating about a third axis (second axis) J3 with respect to the first arm 30, the third axis J3 being parallel to the second axis J2. Furthermore, the robot 100 includes a three-axis wrist unit 50 attached to a distal end of the second arm 40.

The wrist unit 50 includes a first wrist element 51 that is supported to be capable of rotating about a fourth axis (third axis) J4 with respect to the second arm 40, the fourth axis J4 extending along a plane orthogonal to the third axis J3. In addition, the wrist unit 50 includes a second wrist element 52 that is supported to be capable of rotating about a fifth axis J5 with respect to the first wrist element 51, the fifth axis J5 being orthogonal to the fourth axis J4. Furthermore, the wrist unit 50 includes a third wrist element 53 that is supported to be capable of rotating about a sixth axis J6 with respect to the second wrist element 52, the sixth axis J6 being orthogonal to the fifth axis J5 and passing through the intersection of the fourth axis J4 and the fifth axis J5. A welding torch (tool) 70 is mounted on a distal end of the third wrist element 53.

The first arm 30 is formed in an elongated cylindrical shape having a hollow portion in the interior thereof, and, as shown in FIG. 1, a proximal-end side thereof is supported to be capable of rotating about the second axis J2 with respect to a top portion of the rotation body 20. In addition, when the robot 100 is in a basic posture, as shown in FIG. 1, the first arm 30 is bent so that a center portion thereof in a longitudinal direction protrudes rearward.

Here, the basic posture refers to a posture of the robot 100 disposed at the position (origin position) where a straight line orthogonal to the second axis J2 and the third axis J3 extends in a vertical direction and the fourth axis J4 extends in a horizontal direction. In addition, a distal-end side of the second arm 40 in this basic posture is defined as the front.

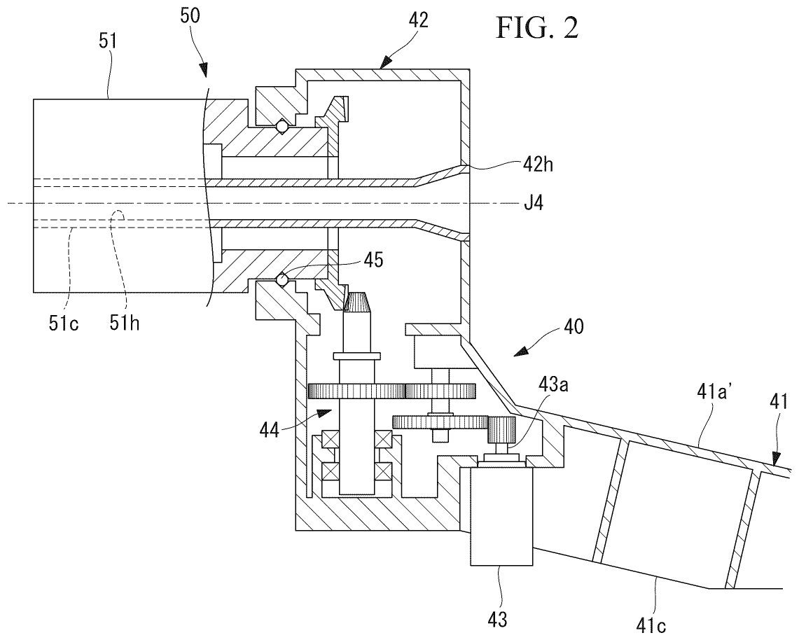

As shown in FIGS. 1 and 2, the second arm 40 includes: a beam-shaped first portion 41 that extends in a direction orthogonal to the third axis J3; and a second portion 42 that is integrally provided on a distal-end side of the first portion 41.

In this embodiment, when the robot 100 is in the basic posture, the second arm 40 is disposed such that the fourth axis J4 is disposed at a position offset upward with respect to a horizontal plane including the third axis J3.

A proximal end of the first portion 41 is connected to a distal end of the first arm 30 to be capable of rotating about the third axis J3. In addition, the proximal end of the first portion 41 is provided with a through-hole 41h that extends in a direction intersecting the third axis J3 along a plane including the first axis J1 and the fourth axis J4.

The through-hole 41h extends diagonally downward and rearward when the robot 100 is in the basic posture.

In addition, the first portion 41 includes, in an intermediate portion in the longitudinal direction thereof, a device installation section 41a having a device mounting surface 41a′ provided with a plurality of screw holes (not shown) for fixing a wire feeding device (relay device) 60, described later.

When the robot 100 is in the basic posture, as shown in FIG. 1, the device mounting surface 41a′ is disposed facing up and is inclined so that a distal-end side thereof is disposed higher than a proximal-end side thereof.

Specifically, when the robot 100 is in the basic posture, the wire feeding device 60 is disposed so as to be inclined in a front-to-rear direction with respect to the fourth axis J4 as a result of being mounted on the device mounting surface 41a′.

In addition, a motor (actuator) 43 for driving the first wrist element 51 of the wrist unit 50 is attached to a side surface of the second arm 40, the side surface being on a back surface side of the device mounting surface 41a′. Furthermore, as shown in FIG. 2, the second arm 40 includes a pair of walls 41c at positions where the walls 41c extend from side surfaces on the back surface side of the device mounting surface 41a′ so as to sandwich the motor 43 from two sides thereof in a third axis J3 direction.

As shown in FIG. 2, the second portion 42 includes, in the interior thereof formed so as to be hollow, a gear reducer (actuator) 44 that reduces the rotational speed of a shaft 43a of the motor 43 fixed to the first portion 41. In addition, the second portion 42 includes a through-hole 42h in which the fourth axis J4 serves as the center axis thereof. Specifically, the through-hole 42h is provided in a surface on a proximal-end side of the second portion 42 at a position of the fourth axis J4 distant upward from the device mounting surface 41a′.

As shown in FIG. 2, the first wrist element 51 is supported on a distal-end side of the second portion 42 of the second arm 40 to be capable of rotating about the fourth axis J4 by means of a bearing 45. The first wrist element 51 includes a cylindrical portion 51c having a through-hole 51h coaxially disposed with the through-hole 42h of the second arm 40. In addition, each of the second wrist element 52 and the third wrist element 53 is provided with a through-hole 53h extending along the sixth axis J6.

The operation of the thus-configured robot 100 according to this embodiment will be described below.

In order to perform arc welding by employing the robot 100, first, the wire feeding device 60 is mounted on the device mounting surface 41a′ of the second arm 40, and the welding torch 70 is attached to the distal end of the third wrist element 53 along the sixth axis J6.

Next, a wire reel (not shown) disposed outside the robot 100 and a rear-end surface (side surface) 60b of the wire feeding device 60 are connected to each other by means of a conduit (first wire material) 62. In addition, a front-end surface (side surface) 60a of the wire feeding device 60 and the welding torch 70 are connected to each other by means of a conduit (second wire material) 63.

In this case, the wire feeding device 60 is a device for pulling out a welding wire W from the wire reel and feeding the welding wire W to the welding torch 70.

The wire feeding device 60 is fixed to the device mounting surface 41a′ by means of bolts (not shown) screwed to the plurality of screw holes provided in the device mounting surface 41a′ of the second arm 40. Accordingly, the wire feeding device 60 is mounted on the device installation section 41a with the rear-end surface 60b facing a third axis J3 side and the front-end surface 60a facing a fourth axis J4 side.

A distal end of the conduit 62 is connected to the vicinity of the center of the rear-end surface 60b of the wire feeding device 60 so as to be orthogonal to the rear-end surface 60b. A proximal end of the conduit 62 is disposed, for example, in the vicinity of the external wire reel, and the distal end thereof is pulled out upward from the through-hole 20h in an upper surface of the rotation body 20 via the interior of the base 10 as shown in FIG. 1. The conduit 62 that has been pulled out upward from the rotation body 20 is erected along a side surface of the first arm 30 and is connected to the rear-end surface 60b of the wire feeding device 60 after passing through the through-hole 41h provided in the first portion 41 of the second arm 40.

In addition, the conduit 62 is guided along the bent shape of the first arm 30 as a result of an intermediate portion in the longitudinal direction thereof passing through a through-hole (not shown) of a guide member 65 attached to the side surface of the first arm 30.

Accordingly, when the robot 100 is in the basic posture, the conduit 62 intersects the third axis J3 from below the second arm 40 along a diagonally upward and forward path, which is an upward extension of the bent shape of the first arm 30. In addition, because the third axis J3 laterally extends across the interior of the through-hole 41h, the conduit 62 passing through the through-hole 41h is maintained in a state of intersecting the third axis J3.

In addition, because the first arm 30 has a rearward bent shape, it is possible to compulsorily guide the conduit 62 that is disposed along the bent shape and that has passed through the through-hole 41h of the second arm 40 to the wire feeding device 60 positioned forward. In addition, by bending an intermediate portion in the longitudinal direction of the first arm 30 rearward, it is possible to configure to have so-called a deep working space of the robot 100, and it is possible to reduce interference between an external member and the first arm 30 in the work performed in front of the robot 100.

On the other hand, a conduit 63 is connected to the vicinity of the center of the front-end surface 60a of the wire feeding device 60 so as to be orthogonal to the front-end surface 60a. A proximal end of the conduit 63 is connected to the front-end surface 60a of the wire feeding device 60, and a distal end thereof passes through the through-hole 42h of the second portion 42 of the second arm 40 and the through-hole 51h of the first wrist element 51. Subsequently, the conduit 63 is bent downward in the vicinity of the fifth axis J5, passes through the through-hole 53h provided in the second wrist element 52 and the third wrist element 53 extending along the sixth axis J6, and is connected to the welding torch 70.

In this case, when the wire feeding device 60 is mounted on the device mounting surface 41a′, due to the inclination of the device mounting surface 41a′, the position of the rear-end surface 60b where the conduit 62 is connected is disposed in a direction facing the third axis J3. On the other hand, the position of the front-end surface 60a where the conduit 63 is connected is disposed in a direction facing the opening of the through-hole 42h in the second portion 42.

Specifically, the wire feeding device 60 on the device mounting surface 41a′ is inclined in a direction in which the position where the conduit 63 is connected to the front-end surface 60a is brought close to the fourth axis J4 and the position where the conduit 62 is connected to the rear-end surface 60b is brought close to the third axis J3.

Therefore, the conduit 62 connected to the rear-end surface 60b of the wire feeding device 60 is disposed in a path extending so as to intersect the third axis J3 without being bent by a large amount. In addition, the conduit 63 connected to the front-end surface 60a of the wire feeding device 60 enters the through-hole 42h without being bent by a large amount and is disposed in a path extending along the fourth axis J4.

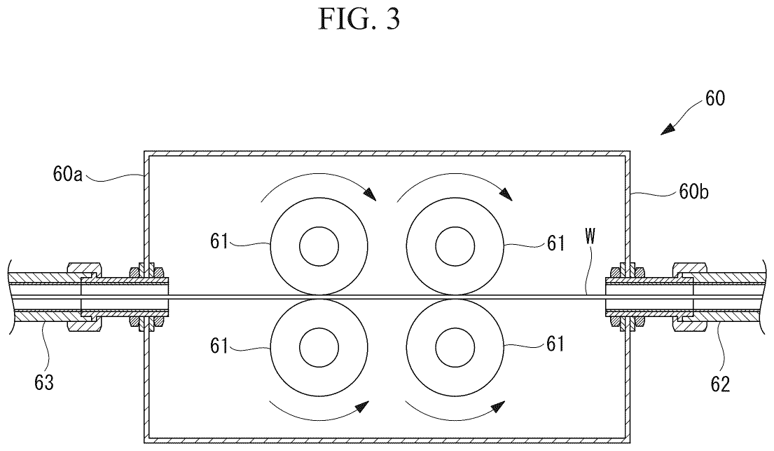

In addition, as shown in FIG. 3, two pairs of rollers 61 that sandwich the welding wire W and motors (not shown) that drive the two pairs of rollers 61 are disposed in the interior of the wire feeding device 60. As a result of the two pairs of rollers 61 being rotated, the welding wire W is pulled out from the wire reel, passes through the conduit 62, and is introduced into the wire feeding device 60. Then, the welding wire W introduced into the wire feeding device 60 passes through the conduit 63 and is fed to the welding torch 70.

Next, when arc welding is executed with the robot 100 in this state, the respective joints of the robot 100 are rotated about the respective corresponding axes J1-J6, and the welding torch 70 is disposed at a desired position and in a desired orientation.

In this case, when the second arm 40 is rotated about the third axis J3 with respect to the first arm 30, the wire feeding device 60 also rotates about the third axis J3 with respect to the first arm 30. Also, in association with this movement, a bending force also acts on the conduit 62 connected to the wire feeding device 60; however, because the conduit 62 passes through the third axis J3, which is the rotational center, it is possible to suppress the bending force to be small.

Specifically, in the case in which the robot 100 is in the basic posture, because the conduit 62 extends in a relatively straight manner, it is possible to prevent the bending radius of the conduit 62 from becoming excessively small regardless of the direction in which the second arm 40 is rotated from the basic posture. As a result, it is possible to maintain a large bending radius of the welding wire W passing through the interior of the conduit 62, and there is an advantage in that it is possible to prevent the feedability of the welding wire W from being deteriorated.

In addition, because the conduit 62 is disposed so as to pass through the third axis J3, which is the rotational center of the second arm 40, it is possible to suppress swing generated when the second arm 40 is rotated to be small. Accordingly, even if the second arm 40 is rotated by a large amount about the third axis J3, it is possible to prevent the conduit 62 from violently moving and interfering with other members disposed in the periphery of the robot 100.

In addition, because the position of the front-end surface 60a of the wire feeding device 60 where the conduit 63 is connected is disposed facing the through-hole 42h of the second arm 40, it is possible to insert the conduit 63 into the through-hole 42h without bending the conduit 63 by a large amount. Accordingly, there is an advantage in that it is possible to ensure a large bending radius of the welding wire W that is made to pass through the interior of the conduit 63.

In addition, in the example shown in FIG. 1, because the device mounting surface 41a′ of the second arm 40 is inclined to face diagonally upward and forward, it is possible to ensure a large space at a lower space of the distal-end side of the first portion 41. Because of this, it is possible to dispose the motor 43 for driving the first wrist element 51 and the gear reducer 44a by utilizing this space, and it is possible to suppress protrusions of the robot 100 in a left-to-right direction.

In addition, it is possible to protect the motor 43 from outside by sandwiching the motor 43 from the two sides thereof in the third axis J3 direction by the walls 41c provided in a lower portion of the first portion 41 of the second arm 40, and it is possible to enhance the mechanical strength of the first portion 41.

Note that, in this embodiment, the walls 41c are disposed at positions where the walls 41c surround the two sides of the motor 43 in the third axis J3 direction; however, alternatively, the walls 41c may be disposed at positions where the walls 41c cover at least a portion of the motor 43.

In addition, in this embodiment, the fourth axis J4 is disposed at the position offset upward with respect to the third axis J3; however, alternatively, the third axis J3 and the fourth axis J4 may be disposed in the same plane.

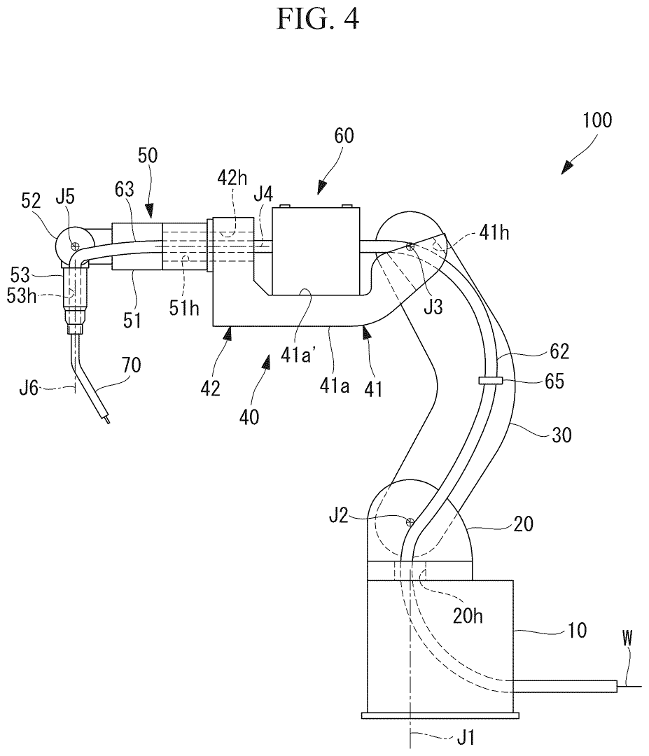

For example, as shown in FIG. 4, the first portion 41 may have a depression so that the device mounting surface 41a′ of the second arm 40 is disposed below the third axis J3 in the case in which the robot 100 is in the basic posture.

Accordingly, it is possible to suppress the amount by which the wire feeding device 60 attached to the device mounting surface 41a′ protrudes upward to be small, and it is possible to suppress the space required when operating the robot 100 to be smaller.

In addition, in this embodiment, the second arm 40 is formed so that the device mounting surface 41a′ is disposed facing up when the robot 100 is in the basic posture.

Specifically, a lower surface of the wire feeding device 60 is secured to the device mounting surface 41a′.

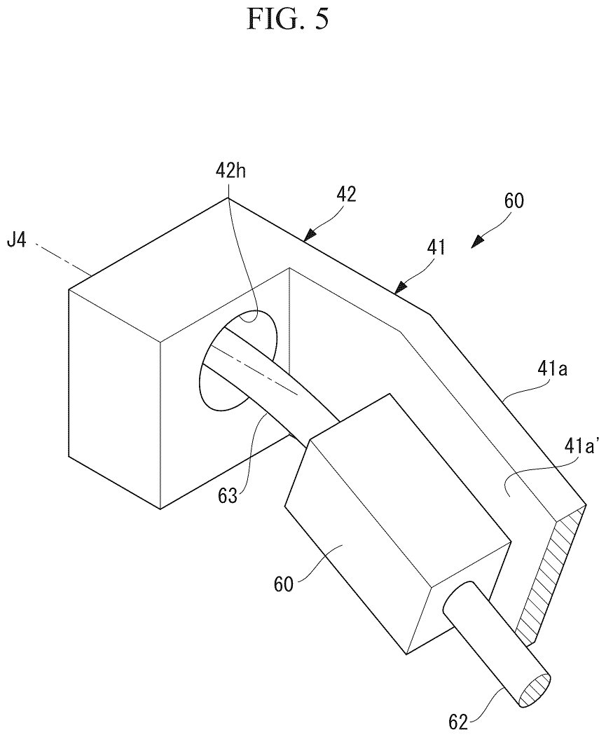

Alternatively, as shown in FIG. 5, the second arm 40 may be configured so that the device mounting surface 41a′ is disposed along a plane orthogonal to the third axis J3 in the state in which the robot 100 is in the basic posture. In this case, a side surface of the wire feeding device 60 in the width direction is secured to the device mounting surface 41a′ instead of the lower surface thereof.

Next, a robot 200 according to a second embodiment of the present disclosure will be described below with reference to the drawings.

In the following description, portions having the same or similar configurations as the above-described robot 100 will be given the same reference signs and the descriptions thereof will be omitted.

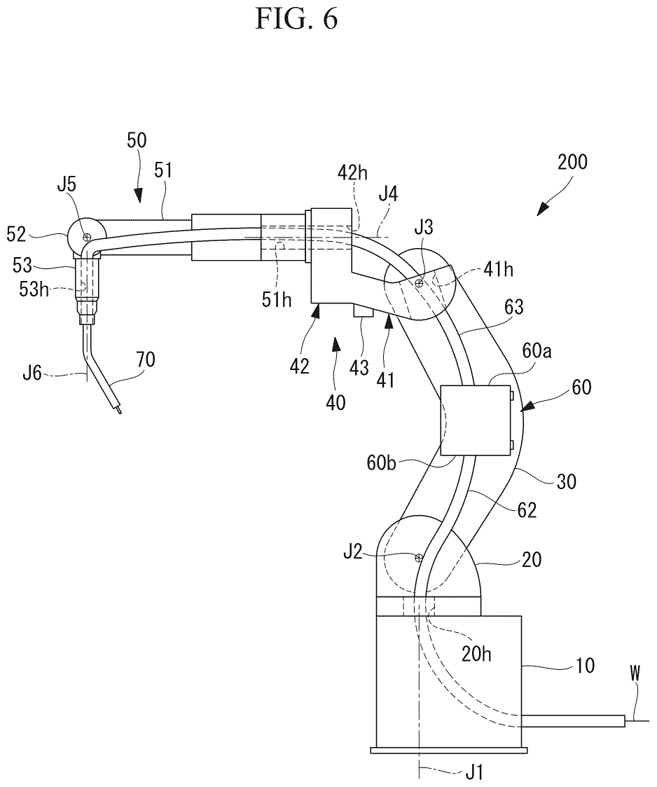

As shown in FIG. 6, the robot 200 according to this embodiment includes, in the first arm 30, the device installation section 41a for mounting the wire feeding device 60.

The wire feeding device 60 is secured to a side surface at a center position in the longitudinal direction of the first arm 30 in a posture in which the rear-end surface 60b faces the second axis J2 side and the front-end surface 60a faces the third axis J3 side. Specifically, the device installation section 41a includes the device mounting surface 41a′ for securing the wire feeding device 60 in the side surface at the center position in the longitudinal direction of the first arm 30.

In this case, for example, the proximal end of the conduit 62 is disposed in the vicinity of the external wire reel, and the distal end thereof is pulled out upward from the through-hole 20h in the upper surface of the rotation body 20 via the interior of the base 10. Subsequently, the conduit 62 is erected along the shape of the first arm 30 along the shape of the proximal-end side of the first arm 30 compared to the center in the longitudinal direction, and the distal end thereof is connected to the rear-end surface 60b of the wire feeding device 60.

On the other hand, the proximal end of the conduit 63 is connected to the front-end surface 60a of the wire feeding device 60, and the distal end thereof passes through the through-hole 41h of the second arm 40, and is introduced into the through-hole 42h of the second arm 40. Subsequently, the distal end of the conduit 63 is disposed in the same manner as in the above-described robot 100, and is connected to the welding torch 70 at the distal end.

Accordingly, when the robot 200 is in the basic posture, it is possible to dispose the conduit 63 in a bent manner so as to compulsorily pass through the third axis J3 toward the front side of and above the third axis J3 from a rear side and below the third axis J3. Therefore, in this case, it is possible to ensure a large bending radius of the conduit 63, and it is possible to suppress swing of the conduit 63 associated with the operation of the second arm 40 to be small.

In addition, because the conduits 62 and 63 are connected to the wire feeding device 60 disposed at the center position in the longitudinal direction of the first arm 30, it is possible to easily dispose the conduits 62 and 63 along the bent shape of the first arm 30. Therefore, it is possible to omit the guide member 65 that guides the conduit 62 so as to be disposed along the side surface of the first arm 30.

In addition, in this case, because it is not necessary to set the device installation section 41a in the second arm 40, it is possible to configure the first portion 41 to be smaller. Accordingly, it is possible to configure a distal-end side of the robot 200 to be slimmer, which is particularly advantageous in the case in which the robot 200 is used in an environment with a small work space.

Next, a robot 300 according to a third embodiment of the present disclosure will be described below with reference to the drawings.

In the following description, portions having the same or similar configurations as the above-described robot 100 or 200 will be given the same reference signs and the descriptions thereof will be omitted.

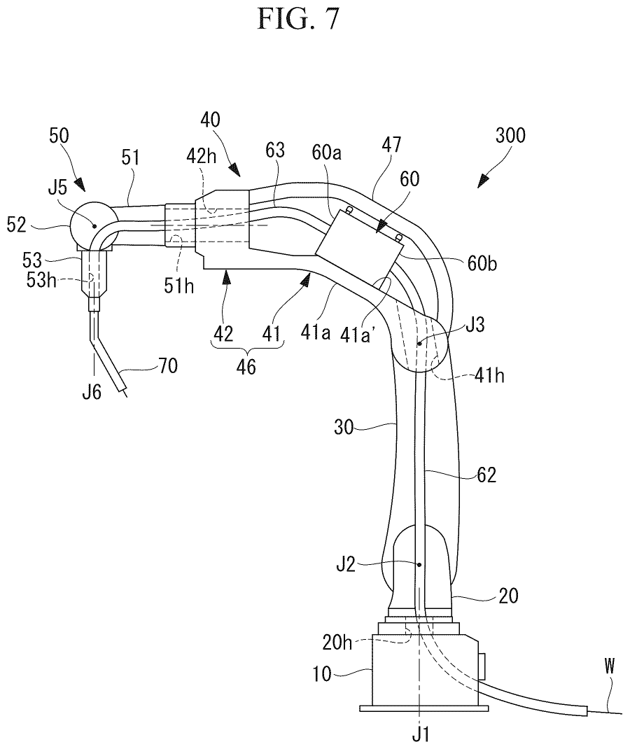

As shown in FIG. 7, in the robot 300 according to this embodiment, the first arm 30 is a beam-shaped member that extends in a straight line along the first axis J1 in the case in which the robot 300 is in the basic posture.

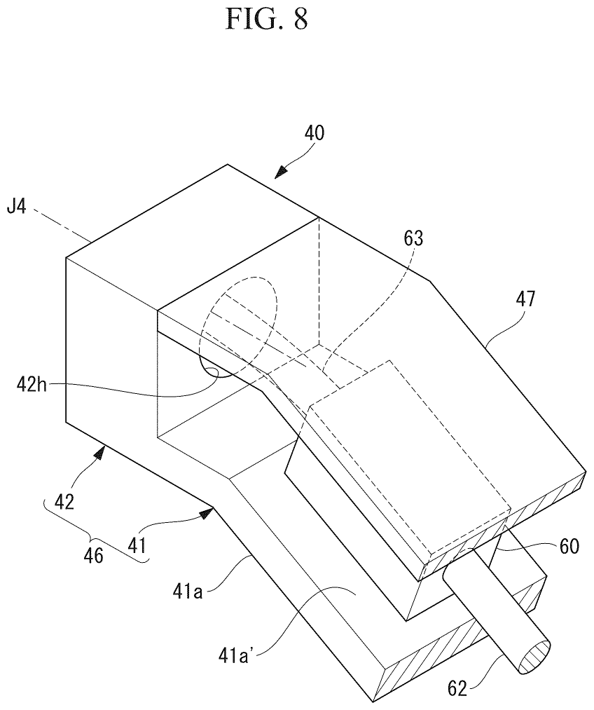

In this case, as shown in FIGS. 7 and 8, the second arm 40 in this embodiment consists of two members, namely a body 46 and a reinforcement member 47.

The body 46 includes the beam-shaped first portion 41 extending in the direction orthogonal to the third axis J3, and the second portion 42 integrally provided on the distal-end side of the first portion 41. Specifically, the body 46 is a member corresponding to the second arm 40 of the above-described robot 100.

The reinforcement member 47 is a member formed into an arch shape by, for example, bending a flat plate formed from the same material as the body 46 in one direction in a plate-thickness direction. One end in the longitudinal direction of the reinforcement member 47 formed in the arch shape is secured, in a detachable manner, to a distal end of the body 46, in other words, an upper end of the second portion 42, by means of bolts or the like. Similarly, the other end in the longitudinal direction of the reinforcement member 47 is secured to a proximal end of the body 46, in other words, the proximal end of the first portion 41. Specifically, as shown in FIG. 7, the reinforcement member 47 connects the distal end and the proximal end of the body 46 by extending above and across the wire feeding device 60 installed on the device mounting surface 41a′.

Accordingly, the second portion 42 of the body 46 is supported by not only the first portion 41 but also the reinforcement member 47; therefore, it is possible to enhance the rigidity of the body 46, and it is possible to effectively suppress the deformation of the body 46.

For example, when the second arm 40 is rotated about the third axis J3 with respect to the first arm 30, an inertial force in a direction opposite from the rotation direction acts on the second arm 40. In particular, because the weight of the wire feeding device 60 is added, a larger inertial force acts on the body 46; however, because the body 46 is reinforced, it is possible to prevent the body 46 from being bent due to the inertial force acting thereon.

Therefore, it is possible to more stably support the wire feeding device 60, it is possible to precisely move the welding torch 70 to a desired position, and it is possible to enhance the precision of the welding work.

In addition, by detaching the reinforcement member 47 from the body 46 by removing the bolts securing the two ends of the body 46 and the two ends of the reinforcement member 47, it is possible to greatly open up the space above the wire feeding device 60 and the device mounting surface 41a′. Accordingly, it is made easy to access the wire feeding device 60, and it is possible to prevent the work efficiency of maintenance work, etc. of the wire feeding device 60 from being deteriorated.

In addition, this embodiment may be configured so that two side surfaces in the direction along the third axis J3 of the wire feeding device 60 disposed between the body 46 and the reinforcement member 47 shown in FIG. 8 are covered with cover members.

In this case, the cover members are, for example, flat plate members formed from a resin material and may have a shape capable of covering, from outside in a direction along the third axis J3, the entire space formed between an upper surface of the first portion 41 and a lower surface of the reinforcement member 47.

By preparing two of such cover members and attaching the cover members to the body 46 or the reinforcement member 47 in a detachable manner, it is possible to protect the wire feeding device 60 from outside by completely surrounding the wire feeding device 60. Therefore, it is possible to omit or simplify a housing or the like provided in the wire feeding device 60 itself for protecting the interior, and it is possible to achieve size and weight reduction of the wire feeding device 60.

In addition, in this case, the two cover members are configured so as to be attached to the body 46 or the reinforcement member 47 in a detachable manner; however, the two cover members may be integrally formed with the reinforcement member 47. Accordingly, it is possible to integrally attach/detach the reinforcement member 47 and the two cover members to/from the body 46, and it is possible to facilitate the assembly work and the disassembly work.

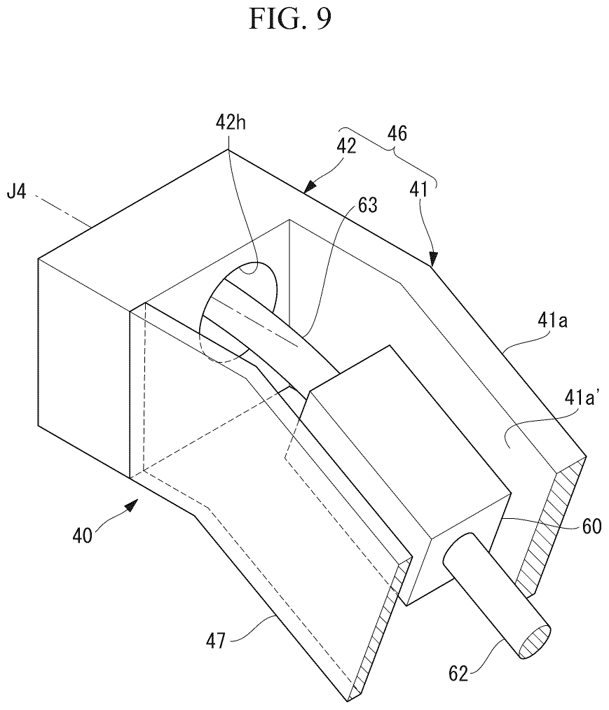

In addition, in this embodiment, the second arm 40 may be configured, as in the embodiment shown in FIG. 5, so that the device mounting surface 41a′ is disposed in the direction orthogonal to the third axis J3 when the robot 300 is in the basic posture. In this case, for example, as shown in FIG. 9, the reinforcement member 47 is disposed on the opposite side from the device mounting surface 41a′ so as to be parallel thereto with the wire feeding device 60 interposed therebetween.

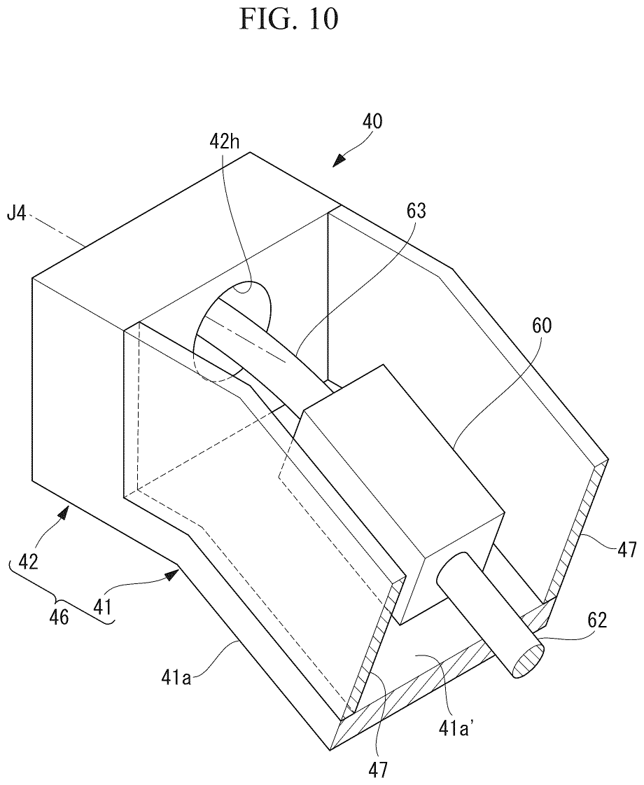

In addition, as shown in FIG. 10, this embodiment may include two reinforcement members 47, and the two reinforcement members 47 may be respectively attached to the upper surface of the first portion 41 along two end edges thereof in the left-to-right direction.

In this case, because the two ends of the body 46 in the longitudinal direction are connected to the two reinforcement members 47, it is possible to further enhance the rigidity of the body 46.

In addition, because the two reinforcement members 47 also play the role of cover members, it is possible to protect the two side surfaces of the wire feeding device 60 in the width direction from outside.

In addition, in this embodiment, the device installation section 41a on which the wire feeding device 60 is mounted is provided in the second arm 40; however, alternatively, the device installation section 41a may be provided in the first arm 30, as with the above-described robot 200.

In this case, the first arm 30 consists of two members, namely the body 46 and the reinforcement member 47.

In addition, although this embodiment has been described in terms of an example in which the reinforcement members 47 are formed from the same material as the body 46, the reinforcement members 47 may be formed from an arbitrary material so long as the reinforcement members 47 have a sufficient strength to reinforce the body 46.

In addition, although the above-described respective embodiments have been described in terms of examples in which the robots are utilized as a welding robot, the robots 100-300 are not limited thereto.

The robots 100-300 may be an arbitrary robot, such as a laser processing robot, sealing robot, or a painting robot, so long as the robot includes a relay device that relays a tool mounted on a distal end thereof and an external device by means of a wire material.

For example, in the case in which the robots 100-300 are utilized as a laser processing robot, a laser processing head is attached instead of the welding torch 70, and a laser oscillator is attached instead of the wire feeding device 60. In this case, a light guide path that connects an external control device and the laser oscillator is provided instead of the conduit 62, and a light guide path that connects the laser oscillator and the laser processing head is provided instead of the conduit 63. Accordingly, it is possible to achieve the same effects as those described above.

As above, the embodiments of the present disclosure have been described in detail; however, the present disclosure is not limited to the above-described individual embodiments.

Various additions, replacements, alterations, partial deletions, etc. can be applied to said embodiments within the range that does not depart from the scope of the invention or the range that does not depart from the concept and purpose of the present invention derived from the contents set forth in the claims and the equivalents thereof. For example, in the above-described embodiments, the order of the respective operations and the order of the respective processing are presented as examples, and are not limited thereto.

The following appended features will be further disclosed regarding the above-described embodiments and modifications.

### Appendix 1

A robot comprising:
a first arm supported to be rotatable about a first axis;
a second arm supported to be rotatable about a second axis parallel to the first axis with respect to the first arm; and
a wrist unit supported, at a distal end of the second arm, to be rotatable about a third axis extending along a plane that is offset by a prescribed amount with respect to a plane including the second axis, wherein
the first arm or the second arm is provided with a device installation section on which a relay device can be installed, the device installation section is positioned between the first axis and a distal end of the second arm, and
the device installation section is configured to install the relay device thereto such that a first wire material that extends along the first arm and that is connected to the relay device and a second wire material that extends from the relay device toward a distal-end side of the second arm are orthogonal to the second axis and extend along a plane that includes the third axis, and an intermediate portion in the longitudinal direction of the first wire material or the second wire material is disposed in a path intersecting the second axis.

### Appendix 2

The robot according to Appendix 1, wherein the first wire material and the second wire material are respectively connected to a pair of side surfaces disposed on opposing sides of the relay device.

### Appendix 3

The robot according to Appendix 1 or 2, wherein:
the device installation section is provided in the second arm; and
the intermediate portion in the longitudinal direction of the first wire material is disposed in the path intersecting the second axis.

### Appendix 4

The robot according to Appendix 3, wherein the relay device can be installed on the device installation section so as to be inclined in a direction in which a position where the first wire material is connected to the relay device is brought close to the second axis and the position where the second wire material is connected to the relay device is brought close to the third axis.

### Appendix 5

The robot according to Appendix 4, wherein:
the device installation section includes a device mounting surface to which the relay device is mounted; and
an actuator that drives the wrist unit is disposed on a back surface side of the device mounting surface of the second arm.

### Appendix 6

The robot according to Appendix 5, wherein the device mounting surface is a flat surface parallel to the second axis.

### Appendix 7

The robot according to Appendix 6, wherein the second arm includes a wall that is disposed at least on one side in a second axis direction of the actuator.

### Appendix 8

The robot according to Appendix 5, wherein the device mounting surface is a flat surface intersecting to the second axis.

### Appendix 9

The robot according to Appendix 1 or 2, wherein:
the device installation section is provided in the first arm; and
an intermediate portion in the longitudinal direction of the second wire material is disposed in the path intersecting the second axis.

### Appendix 10

The robot according to any one of Appendixes 1 to 9, wherein assuming that the distal-end side of the second arm is a front side, at an origin position where the second arm is disposed in a direction orthogonal to a straight line orthogonal to the first axis and the second axis,
wherein the first arm has a shape bent rearward.

### Appendix 11

The robot according to Appendix 10 further comprising a guide member that guides the first wire material along a bent shape of the first arm.

### Appendix 12

The robot according to any one of Appendixes 1 to 11, wherein the first arm or the second arm comprises: a body including the device installation section; and a reinforcement member that is provided across a distal end and a proximal end of the body, the distal end and the proximal end are disposed so as to sandwich the device installation section, and the reinforcement member connects the distal end and the proximal end.

### Appendix 13

The robot according to Appendix 12, wherein the reinforcement member is attached to the body in a detachable manner.

### Appendix 14

The robot according to Appendix 12 or 13, wherein the reinforcement member is disposed on an opposite side of the device installation section with the relay device interposed therebetween.

### Appendix 15

The robot according to any one of Appendixes 12 to 14 further comprising a cover member that is attached to at least one of the body and the reinforcement member and that covers at least a portion of the relay device.

### Appendix 16

The robot according to any one of Appendixes 1 to 15 further comprising:
a base fixed to an installation surface; and
a rotation body supported to be rotatable about a basic axis with respect to the base, the basic axis extending in a direction orthogonal to the installation surface, wherein
the first arm is supported to be rotatable about the first axis with respect to the rotation body.

1. A robot comprising:
a first arm supported to be rotatable about a first axis;
a second arm supported to be rotatable about a second axis parallel to the first axis with respect to the first arm; and
a wrist unit supported, at a distal end of the second arm, to be rotatable about a third axis extending along a plane that is offset by a prescribed amount with respect to a plane including the second axis, wherein
the first arm or the second arm is provided with a device installation section on which a relay device can be installed, the device installation section is positioned between the first axis and a distal end of the second arm, and
the device installation section is configured to install the relay device thereto such that a first wire material that extends along the first arm and that is connected to the relay device and a second wire material that extends from the relay device toward a distal-end side of the second arm are orthogonal to the second axis and extend along a plane that includes the third axis, and an intermediate portion in the longitudinal direction of the first wire material or the second wire material is disposed in a path intersecting the second axis.

2. The robot according to claim 1, wherein the first wire material and the second wire material are respectively connected to a pair of side surfaces disposed on opposing sides of the relay device.

3. The robot according to claim 1, wherein:
the device installation section is provided in the second arm; and
the intermediate portion in the longitudinal direction of the first wire material is disposed in the path intersecting the second axis.

4. The robot according to claim 3, wherein the relay device can be installed on the device installation section so as to be inclined in a direction in which a position where the first wire material is connected to the relay device is brought close to the second axis and the position where the second wire material is connected to the relay device is brought close to the third axis.

5. The robot according to claim 4, wherein:
the device installation section includes a device mounting surface to which the relay device is mounted; and
an actuator that drives the wrist unit is disposed on a back surface side of the device mounting surface of the second arm.

6. The robot according to claim 5, wherein the device mounting surface is a flat surface parallel to the second axis.

7. The robot according to claim 6, wherein the second arm includes a wall that is disposed at least on one side in a second axis direction of the actuator.

8. The robot according to claim 5, wherein the device mounting surface is a flat surface intersecting to the second axis.

9. The robot according to claim 1, wherein:
the device installation section is provided in the first arm; and
an intermediate portion in the longitudinal direction of the second wire material is disposed in the path intersecting the second axis.

10. The robot according to claim 1, wherein assuming that the distal-end side of the second arm is a front side, at an origin position where the second arm is disposed in a direction orthogonal to a straight line orthogonal to the first axis and the second axis,
wherein the first arm has a shape bent rearward.

11. The robot according to claim 10 further comprising a guide member that guides the first wire material along a bent shape of the first arm.

12. The robot according to claim 1, wherein the first arm or the second arm comprises: a body including the device installation section; and a reinforcement member that is provided across a distal end and a proximal end of the body, the distal end and the proximal end are disposed so as to sandwich the device installation section, and the reinforcement member connects the distal end and the proximal end.

13. The robot according to claim 12, wherein the reinforcement member is attached to the body in a detachable manner.

14. The robot according to claim 12, wherein the reinforcement member is disposed on an opposite side of the device installation section with the relay device interposed therebetween.

15. The robot according to claim 12 further comprising a cover member that is attached to at least one of the body and the reinforcement member and that covers at least a portion of the relay device.

16. The robot according to claim 1 further comprising:
a base fixed to an installation surface; and
a rotation body supported to be rotatable about a basic axis with respect to the base, the basic axis extending in a direction orthogonal to the installation surface, wherein
the first arm is supported to be rotatable about the first axis with respect to the rotation body.
